(19) United States
(12) Patent Application Publication
(10) Pub. No.: US 2005/0006951 A1
(43) Pub. Date: Jan. 13, 2005

(54) Electromagnetic valve

(76) Inventors: Paul Schwarzer, Kriftel (DE); Andreas Richter, Neu-Anspach (DE); Harald Kahl, Limburg (DE); Joachim Bohn, Hundasangen (DE)

Correspondence Address: Paul P Seitter;Ratner Prestia, Suite 301One Westlakes Berwyn, P O Box 980, Valley Forge, PA, 19482-0980, US

(21) Appl. No.: 10/496,339

(22) PCT Filed: Dec. 4, 2002
(86) PCT No.: PCT/EP02/13699

(30) Foreign Application Priority Data
Dec. 8, 2001 (DE) 10160427.0
Dec. 8, 2001 (DE) 10160428.9
Dec. 18, 2001 (DE) 10162186.8
Dec. 18, 2001 (DE) 10162165.5
May 2, 2002 (DE) 10219426.2

(51) Int. Cl. B60T 8/36

(52) U.S. Cl. 303/119.2

(57) ABSTRACT

The present invention relates to an electromagnetic valve, which is electrically switched to adopt a throttled position in brake pressure control for reducing valve switching noises.

### TECHNICAL FIELD

The present invention relates to an electromagnetic valve, in particular for slip-controlled motor vehicle brake systems.

### BACKGROUND OF THE INVENTION

DE 43 39 305 A1 discloses an electromagnetic valve of binary operation for use in a slip-controlled motor vehicle brake system, the valve closure member of which remains either in a closed or a fully opened switch position in relation to the valve seat. To avoid the undesirable switching noise of the electromagnetic valve, a hydraulically operated switching piston is arranged in the electromagnetic valve, switching into a position that throttles the valve passage when a defined pressure difference is reached. The effort in construction entailed for noise reduction by hydraulically throttling the pressure fluid is significant.

In view of the above, it is an object of the invention to improve an electromagnetic valve of the indicated type to the effect that the above-mentioned shortcoming is avoided.

### BRIEF DESCRIPTION OF THE DRAWINGS

FIG. 1 is a total view of an electromagnetic valve of the type concerned for use in a slip-controlled brake system.

FIG. 2 is a diagram for plotting the brake pressure variation and the current variation for the electromagnetic valve according to FIG. 1.

FIG. 3 is another diagram for plotting an alternative brake pressure and current variation for the electromagnetic valve according to FIG. 1.

### DETAILED DESCRIPTION OF THE PREFERRED EMBODIMENTS

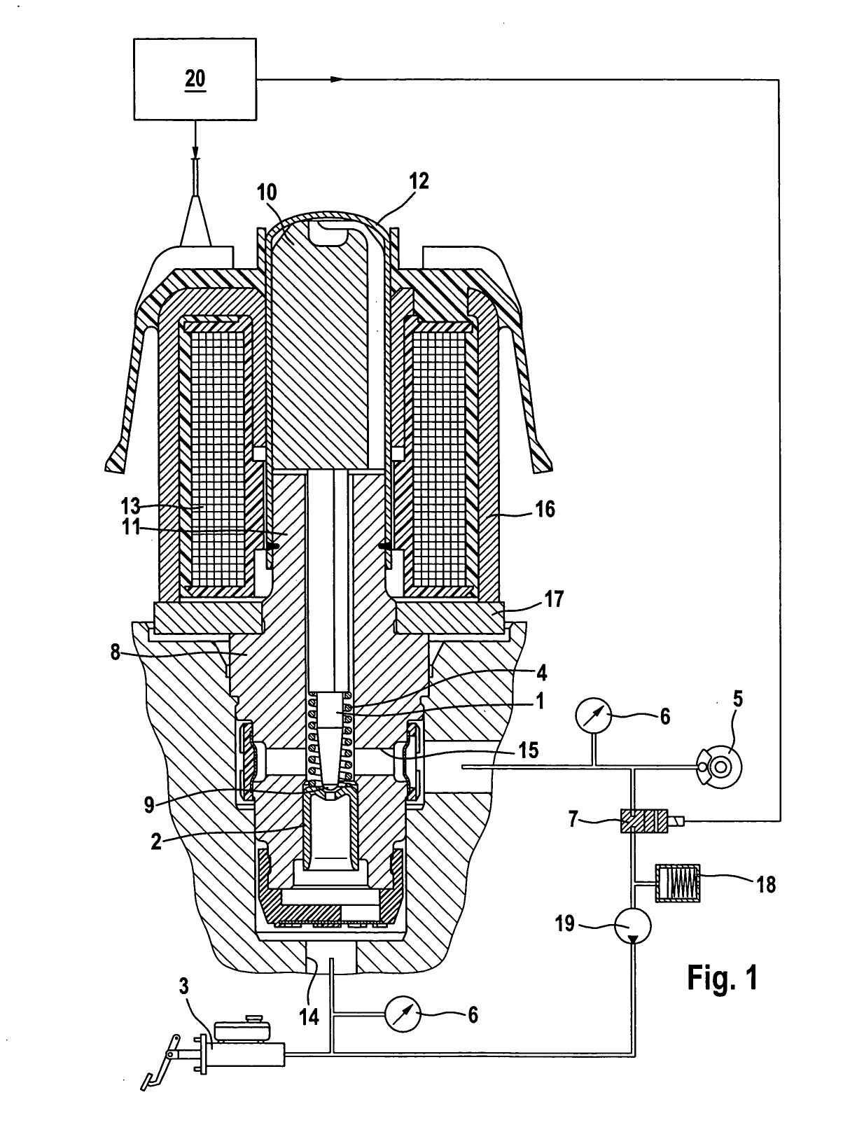

FIG. 1 shows a total view of an electromagnetic valve normally open in its basic position and designed as a two-way/two-position directional seat valve, comprising a cartridge-type valve housing 8 including a spherical valve closure member 9 at a stepped valve tappet 1. Valve tappet 1 is in contact with a cylindrical magnet armature 10 at the opposite frontal end of the valve closure member 9. The valve closure member 9 points to a tubular valve seat member 2, while the oppositely disposed magnet armature 10 faces the magnet core 11 integrated in the valve housing 8. Fastened to the magnet core 11 is a preferably deepdrawn sleeve 12 in which the magnet armature 10 can align itself and move in an axial direction. A magnet coil 13 is arranged at the periphery of sleeve 12 and is embedded between a yoke-type metal sheet 16 and a magnetic plate 17.

In a per se known fashion, the magnet armature 10 moves in the direction of the magnet core 11 during energization of the magnet coil 13 so that the valve closure member 9 shaped at the valve tappet 1 interrupts the pressure fluid connection between a pressure fluid inlet and a pressure fluid outlet channel 14, 15 that is normally open in the basic position, in opposition to the effect of a valve spring 4 interposed between the valve tappet 1 and the valve seat member 2.

The electromagnetic valve is meant for use in slip-controlled motor vehicle brake systems, and its valve closure member 9 cooperating with the magnet armature 10 is lifted in the basic position from the valve seat member 2 by means of the valve spring 4 that is arranged between the valve tappet 1 and the valve seat member 2. In the electrically energized valve position, the valve closure member 9 moves in the direction of the valve seat member 2, and the magnet armature 10 moves in the direction of the magnet core 11. The special feature is that the magnet coil 13 is energized by means of three different switching current values I1, I2, I3 for reducing the valve switching noise. In the electrically non-energized condition of the magnet coil 13, the first switching current value I1=0 so that the valve closure member 9 is completely opened due to the valve spring 4. In the condition partly energized by means of the second switching current value I2 which is higher than the first switching current value I1 but lower than the third switching current value I3, the valve closure member 9 opens a throttle cross-section at the valve seat member 2. To be able to keep this throttle position, it needs a defined geometric design of the valve seat member 2 and the valve tappet 1. Valve closure member 9 at the valve tappet 1 has a preferably spherical contour with a diameter of 1.8 to 2.2 millimeters for this purpose. This corresponds to a sealing diameter at the valve seat of 0.9 to 1.1 millimeters. The valve seat angle amounts to 120 degrees herein.

In the fully energized condition, the electromagnetic valve is closed by the effect of the third switching current value I3. This permits noise reduction without structural modification of the electromagnetic valve.

A tandem master cylinder is connected as a brake pressure generator 3 to the pressure fluid inlet channel 14 of the electromagnetic valve illustrated in FIG. 1. At the level of valve spring 4, the pressure fluid outlet channel 15 of the electromagnetic valve is connected to a wheel brake 5. Connected to said pressure fluid connection that leads to wheel brake 5 is a return line provided with an outlet valve 7 and including a low-pressure accumulator 18 and a pump 19 according to the return delivery principle. Said return line is connected to the pressure fluid inlet channel 14. The illustrated hydraulic circuit is of a principal nature and serves for general explanations. Deviations herefrom are possible.

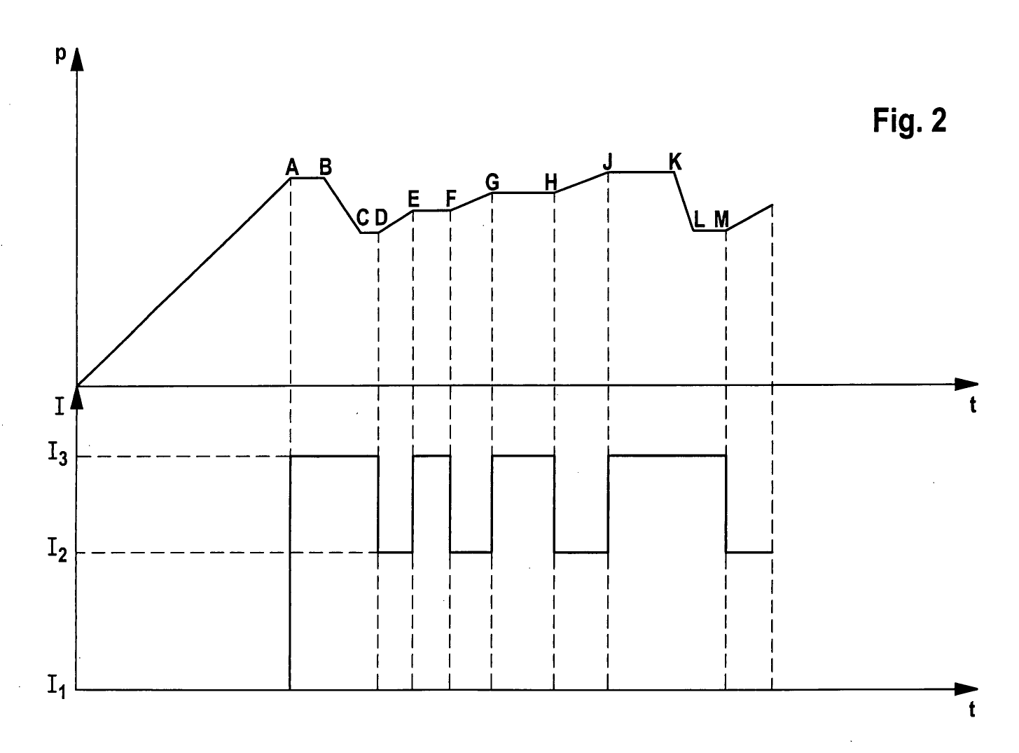

Based on the electrically non-energized condition I1 of the magnetic coil 13 in which the electromagnetic valve is initially completely open, as shown in the drawings, in a brake pressure control operation the electromagnetic valve is principally switched into a fully energized condition I3 where it is completely closed. Subsequently, it is opened electrically only in part (condition I2) for noise reduction, and it is switched to re-assume the completely closed condition I3 only subsequently. Details regarding the control sequence are referred to in the description relating to FIG. 2.

The valve spring 4 is preferably configured as a helical spring and has a progressive spring characteristic curve, the spring force of which is rated so that the valve closure member 9 remains in the partly opened, noise-reducing switching position when the magnet coil 13 adopts its condition partly energized with the second switching current value I2.

For illustrating the hydraulic pressure difference applied to the valve closure member 9 in the partly opened switching position, a means is provided sensing the hydraulic pressure that prevails upstream and downstream of the valve closure member 9. It is of great significance to determine the pressure difference as exactly as possible by way of appropriate means because in the partly opened condition of the electromagnetic valve, the electric switching current value I2 that is necessary for the partial opening of the electromagnetic valve will no longer be sufficient to keep the electromagnetic valve open starting from a defined pressure difference.

As a means for sensing the hydraulic pressure difference, e.g. pressure sensors 6 are well suited that are connected to the brake circuit upstream and downstream of the valve closure member 9. The pressure sensor signals representative of the pressure difference at the valve closure member 9 are evaluated in an electronic controller 20 actuating the magnet coil 13.

According to the illustrated pattern, the electromagnetic valve is inserted into a brake pressure line of a slip-controlled motor vehicle brake system connecting the brake pressure generator 3 to the wheel brake 5 so that alternatively to the pressure sensing by means of pressure sensors 6, the pressure difference can be sensed by appropriate software in a characteristic field for a pressure model, for what purpose the electronic controller 20 actuating the magnet coil 13 is appropriate. The pressure model represents the pressure variation in the wheel brake 5 and in the brake pressure generator 3. Advantageously, it is possible to dispense with the comparatively expensive pressure sensor equipment by using the pressure model.

The pressure model representative of the pressure variation in the wheel brake 5 is computed based on the vehicle-related and brake-specific parameters. Among these parameters is data relating to the vehicle deceleration, the pilot pressure in the brake pressure generator, and the brake pressure increase and brake pressure decrease characteristics. The calculation of the pressure model for the brake pressure generator 3 takes into account the number of the brake pressure increase pulses and/or the duration of the brake pressure increase pulses necessary to complete the desired brake pressure increase by actuating the magnet coil 13. Further, the pressure model for the wheel brake 5 is included in the calculation of the pressure model for the brake pressure generator 3.

FIG. 2 shows a diagram in which, along the ordinate, the brake pressure variation for a slip-controlled wheel brake 5 (cf. FIG. 1) and the three different switching current values I1, I2, I3 of the electromagnetic valve known from FIG. 1 are plotted as a function of time t. The pressure variation rising linearly from the zero point of the axes of coordinates initially represents the slip-free brake pressure increase initiated by the brake pressure generator 3 because the electromagnetic valve is non-energized (I1=0). When the allowable brake pressure value (points A-B) is reached and maintained, the magnetic coil 13 is energized by means of the switching current value I3 that is higher than the switching current values I1, I2, with the result that the valve closure member 9 adopts its closed position. Simultaneously, the outlet valve 7 connected to the wheel brake 5 (cf. FIG. 1) is switched into the open position so that a rapid pressure reduction commences in wheel brake 5 until point C. After an initially steep pressure reduction, there will be a short phase where the pressure in wheel brake 5 is maintained constant after the closing of outlet valve 7 due to the closed position of the valve closure member 9, until the reduction of the switching current value I3 to the switching current value I2 (point D) that reduces the valve noise. By energizing the magnet coil 13 with a switching current value I2, the valve closure member 9 will adopt a throttled position so that the pressure rise in the wheel brake 5 up to point E takes place with a lower pressure rise gradient. Following is a pressure-maintaining phase, to what end the magnet coil 13 is again energized with the maximum switching current value I3, with the result that the valve closure member 9 moves to sit on the valve seat member 2. For the purpose of further throttled pressure increase in the wheel brake 5, the switching current value I3 of the magnet coil 13 is reduced in point F to the noise-reducing switching current value I2, what causes a further throttled pressure rise until point G. Until point H, a pressure-maintaining phase will follow due to the increase of the electric current of I2 to the switching current value I3. Due to the new reduction of the energization of the magnet coil 13 to the switching current value I2, a continued throttled, low-noise pressure rise takes place until point J, which corresponds to the maximum brake pressure value (cf points A, B). Due to the energization of the magnet coil 13 with the switching current value I3, the valve closure member 9 will adopt the closed switch position again so that a pressure-maintaining phase follows until point K. When the maximum brake pressure value causes inadmissible brake slip, the outlet valve 7 allows a quick pressure reduction in the wheel brake 5 until point L is reached, which is again succeeded by a phase where the pressure is maintained constant and a phase of throttled pressure increase.

The brake pressure control operation described herein is based on a so-called current ramp actuation of the electromagnetic valve, whereby lower pressure increase gradients are achieved due to the throttling in the electromagnetic valve, which gradients permit reducing the valve noise and the pedal pulsation during brake pressure control.

Instead of the initially proposed electromagnetic valve that acts as an inlet valve for a brake system and adopts three different switch positions for noise reduction and minimizing the pedal pulsations with three different current values I1, I2, I3, an electromagnetic valve is disclosed to solve the object at issue (based on the valve construction shown in FIG. 1). The magnet coil 13 of said valve is operated with one single switching current value I1 in such a fashion that the electromagnetic valve is never closed completely in the electrically energized condition of the magnet coil 13, but always remains slightly opened so that a pressure fluid connection with a throttle is established between the valve seat 2 and the valve closure member 9 for noise reduction. Consequently, the idea is based on a permanent leakiness at the valve seat member 2 during the energization of the magnet coil 13 with the switching current value I1 so that the valve closure member 9 will never provide complete sealing at the valve seat member 2. Consequently, the idea is based on a permanent leakage at the valve seat member 2 during energization of the magnet coil 13 with the switching current value I1 so that the valve closure member 9 will never fully seal at the valve seat member 2. This obviates the need for a complicated actuation of the electromagnetic valve and thereby minimizes the valve noise and the pedal pulsations, without detrimental influence on brake pressure control in which the outlet valve 7 is to be included.

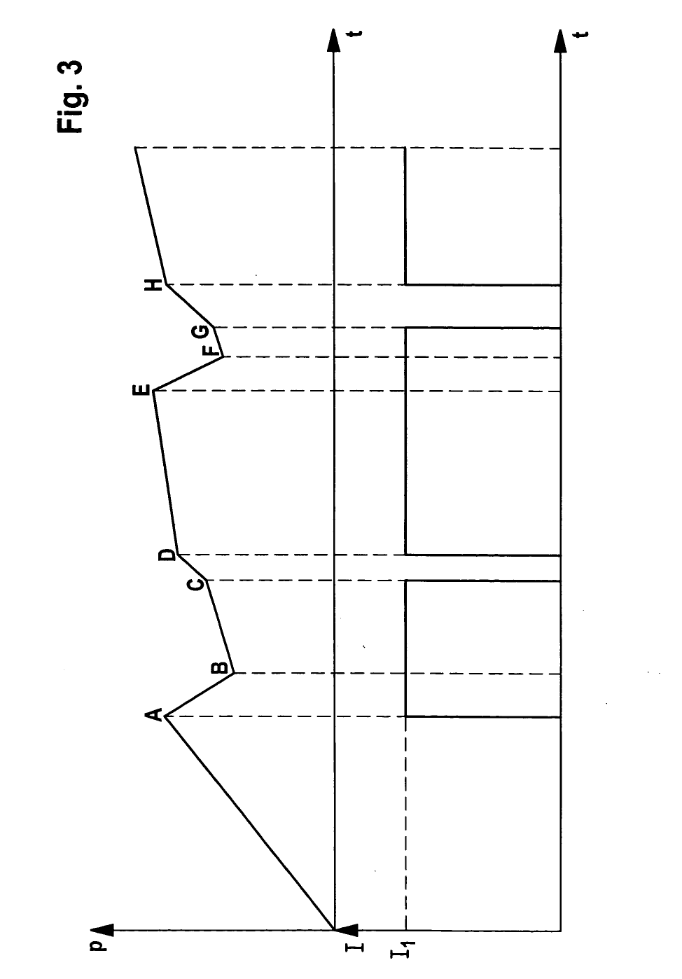

In this respect, FIG. 3 shows a diagram in which the brake pressure variation for a slip-controlled wheel brake 5 (cf FIG. 1) and the switching current value I1 of the electromagnetic valve known from FIG. 1 are plotted along the ordinate as a function of time.

The pressure variation linearly rising from the zero point initially represents the slip-free brake pressure increase initiated by the brake pressure generator 3 because the electromagnetic valve is non-energized (I=0). When the allowable brake pressure value (point A) is reached, the magnet coil 13 is energized with the switching current value I1, with the result that the valve closure member 9 assumes its throttled position. In addition, the outlet valve 7 connected to wheel brake 5 (cf FIG. 1) is switched to adopt its open position so that a rapid pressure reduction commences in wheel brake 5 until point B. After an initially steep pressure reduction, there will be a flat pressure rise in the wheel brake 5 after the outlet valve 7 has closed on account of the throttled position of the valve closure member 9, until the interruption of the partial current value I1 (point C). Due to the effect of valve spring 4, the valve closure member 9 moves from its throttled into the fully open valve switching position, with the result that the pressure gradient rises between points C-D. As soon as the magnet coil 13 is again energized with the partial current value I1 (point D), the valve closure member will again assume its throttled position, with the result that the further pressure rise in the direction of point E occurs with a flat gradient again. When the pressure reduction phase in wheel brake 5 sets in by the outlet valve 7 customary in slip-controlled brake systems opening, the pressure will drop rapidly until the point F of the characteristic curve because the amount of fluid penetrating the outlet valve 7 is of course considerably greater than in the narrowest throttle cross-section of the electromagnetic valve that acts as an inlet valve. When the outlet valve re-adopts its closed position, the pressure in wheel brake 5 will rise slightly corresponding to the throttled position of the valve closure member 9 until point G. When the energization of the magnet coil 13 is interrupted in point G, the electromagnetic valve will switch back into the unthrottled open position, and a rapid pressure increase takes place in wheel brake 5 until point H. When the electromagnetic valve again switches into the throttled position due to the partial current value I1, the flat pressure rise in wheel brake 5 will repeat. Thus, moderation of the valve noise and the pedal pulsations is ensured by the low pressure increase gradients.

1-8. (Cancelled)

9. Electromagnetic valve, in particular for slip-controlled motor vehicle brake systems, comprising:
a valve housing accommodating a valve closure member which cooperates with a magnet armature and, in the basic position, is lifted from the valve seat member by means of a valve spring, with said valve closure member moving in the direction of the valve seat member and the magnet armature moving in the direction of the magnet core in the electrically energized valve position, with a sleeve which is attached to the magnet core and in which the magnet armature is axially movably guided, and with a magnet coil arranged at the periphery of the sleeve for actuation of the magnet armature from the opened into the closed valve switch position, wherein the magnet coil can be actuated by means of invariably adjusted switching current values so that the electromagnetic valve is completely opened in the electrically non-energized condition of the magnet coil, is partly opened for throttling purposes in the partly energized condition, and is closed in the fully energized condition.

10. Electromagnetic valve as claimed in claim 9,
wherein the valve spring has a preferably progressive spring characteristic curve, the spring force of which is rated such that the valve closure member remains in the partly open switch position in the partly energized condition of the magnet coil.

11. Electromagnetic valve as claimed in claim 9,
wherein a means indicative of the hydraulic pressure that prevails upstream and downstream of the valve closure member is provided for realizing the hydraulic pressure difference applied to the valve closure member in the partly opened switch position.

12. Electromagnetic valve as claimed in claim 11,
wherein for sensing the hydraulic pressure difference, pressure sensors are arranged upstream and downstream of the valve closure member and are connected to an electronic controller actuating the magnet coil for the purpose of evaluation of the pressure sensor signals representative of the pressure difference at the valve closure member.

13. Electromagnetic valve as claimed in claim 11, which is inserted into a brake pressure line of a slip-controlled motor vehicle brake system connecting a brake pressure generator to a wheel brake,
wherein a performance graph for a pressure model is stored in an electronic controller actuating the magnet coil for illustrating the hydraulic pressure difference that prevails at the valve closure member in the partly opened switch position, said performance graph representing the pressure variation in the wheel brake and in the brake pressure generator.

14. Electromagnetic valve as claimed in claim 13,
wherein the computation of the pressure model representative of the pressure variation in the wheel brake is performed in dependence on vehicle-related and brake-related parameters such as vehicle deceleration, pilot pressure in the brake pressure generator, brake pressure increase and brake pressure reduction characteristics.

15. Electromagnetic valve as claimed in claim 13,
wherein the computation of the pressure model for the brake pressure generator is performed in dependence on the number of brake pressure increase pulses or in dependence on the duration of the brake pressure increase pulses which are necessary for completion of the desired brake pressure increase by actuating the magnet coil, and in that the calculation is performed by means of the wheel brake pressure known from the pressure model for the wheel brake.

16. Electromagnetic valve as claimed in claim 10,
wherein a means indicative of the hydraulic pressure that prevails upstream and downstream of the valve closure member is provided for realizing the hydraulic pressure difference applied to the valve closure member in the partly opened switch position.

17. Electromagnetic valve as claimed in claim 16,
wherein for sensing the hydraulic pressure difference, pressure sensors are arranged upstream and downstream of the valve closure member and are connected to an electronic controller actuating the magnet coil for the purpose of evaluation of the pressure sensor signals representative of the pressure difference at the valve closure member.

18. Electromagnetic valve as claimed in claim 16, which is inserted into a brake pressure line of a slip-controlled motor vehicle brake system connecting a brake pressure generator to a wheel brake,
wherein a performance graph for a pressure model is stored in an electronic controller actuating the magnet coil for illustrating the hydraulic pressure difference that prevails at the valve closure member in the partly opened switch position, said performance graph representing the pressure variation in the wheel brake and in the brake pressure generator.

19. Electromagnetic valve as claimed in claim 18,
wherein the computation of the pressure model representative of the pressure variation in the wheel brake is performed in dependence on vehicle-related and brake-related parameters such as vehicle deceleration, pilot pressure in the brake pressure generator, brake pressure increase and brake pressure reduction characteristics.

20. Electromagnetic valve as claimed in claim 18,
wherein the computation of the pressure model for the brake pressure generator is performed in dependence on the number of brake pressure increase pulses or in dependence on the duration of the brake pressure increase pulses which are necessary for completion of the desired brake pressure increase by actuating the magnet coil, and in that the calculation is performed by means of the wheel brake pressure known from the pressure model for the wheel brake.

21. Electromagnetic valve, in particular for slip-controlled motor vehicle brake systems, including a valve housing accommodating a valve closure member which cooperates with a magnet armature and, in the basic position, is lifted from the valve seat member by means of a valve spring, with said valve closure member moving in the direction of the valve seat member and the magnet armature moving in the direction of the magnet core in the electrically energized valve position, with a sleeve which is attached to the magnet core and in which the magnet armature is axially movably guided, and with a magnet coil arranged at the periphery of the sleeve for actuation of the magnet armature from the opened into the closed valve switch position,
wherein for reducing the valve switching noise, the magnet coil is operated with one single switching current value in such a manner that the electromagnetic valve remains partly opened in the electrically energized condition of the magnet coil so that a pressure fluid connection with a throttle is provided between the valve seat and the valve closure member.
